(19) United States
(12) Patent Application Publication
(10) Pub. No.: US 2023/0121211 A1
(43) Pub. Date: Apr. 20, 2023

(54) MULTILAYER METASURFACE ARCHITECTURES WITH IMPEDANCE MATCHING

(71) Applicant: Applied Materials, Inc., Santa Clara, CA (US)

(72) Inventors: Jianji YANG, Cupertino, CA (US); David SELL, Santa Clara, CA (US); Samarth BHARGAVA, Saratoga, CA (US); Guannan CHEN, Belmont, CA (US)

(73) Assignee: Applied Materials, Inc., Santa Clara, CA (US)

(21) Appl. No.: 17/955,185

(22) Filed: Sep. 28, 2022

Related U.S. Application Data
(60) Provisional application No. 63/256,425, filed on Oct. 15, 2021.

(51) Int. Cl. G02B 1/00; H01P 1/00

(52) U.S. Cl. CPC G02B 1/002; H01P 1/00

(57) ABSTRACT

Embodiments of the present disclosure generally relate to metasurface devices and methods of forming metasurfaces. The metasurface devices include a plurality of device structures. Each of the device structures are formed from multiple layers, at least one of which is an impedance matching layer. The impedance matching layer may be formed as either an inner impedance matching layer between the substrate and the device layer or as a separate outer impedance matching layer on top of the device layer. The refractive indices of the impedance matching layers are chosen to be between the refractive index of the mediums on either side of the impedance matching layer.

### CROSS-REFERENCE TO RELATED APPLICATIONS

This application claims the benefit of U.S. Provisional Patent Application Ser. No. 63/256,425, filed Oct. 15, 2021, which is incorporated by reference herein in its entirety.

### BACKGROUND

### Field

Embodiments of the present disclosure generally relate to optical devices. More specifically, embodiments described herein relate to metasurface devices and methods of forming metasurfaces with improved optical transmission performance.

### Description of the Related Art

Many sensor apparatuses utilize bulk lenses to collimate and diffract light for sensing applications e.g., facial identification sensors). The sensor apparatuses including the bulk lenses generally have a large form factor, making these sensor apparatuses costly and time consuming to manufacture.

To address the above deficiencies, conventional approaches have utilized flat optical devices. However, flat optical devices do not generally transmit 100% of radiation therethrough. Instead, flat optical devices absorb, scatter, or reflect a portion of the radiation. The absorbed, scattered, or reflected radiation is lost and decreases the efficiency of the flat optical devices. Absorbed radiation further leads to heating of the flat optical devices, which can lead to component failure or a decreased imaging rate which is possible with the flat optical devices.

Accordingly, what is needed in the art is an improved flat optical device.

### SUMMARY

The present disclosure generally relates to a metasurface device. In one embodiment, the metasurface device includes a substrate and a plurality of device structures disposed over the substrate. Adjacent device structures of the plurality of device structures defining a gap therebetween. Each device structure includes a device layer and an impedance matching layer having an impedance refractive index and contacting the device layer. The device layer includes a device material having a device refractive index of about 1.9 to about 3.5. The impedance refractive index is about 1.4 to 1.8.

In another embodiment, a metasurface device is described. The metasurface device includes a substrate and a plurality of device structures disposed over the substrate. Adjacent device structures of the plurality of device structures define a gap therebetween. Each device structure includes an inner impedance matching layer disposed on a top surface of the substrate and having an inner impedance refractive index, a device layer disposed on the inner impedance matching layer and having a device refractive index, and an outer impedance matching layer disposed on the device layer and having an outer impedance refractive index. The inner impedance refractive index is between a substrate refractive index and the device refractive index.

In another embodiment, a method of forming an optical device is described. The method includes forming a material layer stack. The material layer stack includes a device layer disposed on a substrate and an outer impedance matching layer disposed on the device layer. The device layer has a device refractive index of about 1.9 to about 3.5 and the substrate has a substrate refractive index. The outer impedance matching layer has an outer impedance refractive index of about 1.4 to about 1.8. The outer impedance refractive index is between the device refractive index and the surrounding-medium refractive index. The method further includes etching a portion of the outer impedance matching layer to form a hardmask and etching the device layer through the hardmask to form a plurality of device structures.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic cross sectional view of a metasurface device, according to embodiments of the disclosure.

FIG. 2 is a flow diagram of a first method of forming a metasurface device, according to embodiments of the disclosure.

FIGS. 3A-3C are schematic cross sectional views of the metasurface device during the first method of FIG. 2, according to embodiments of the disclosure.

FIG. 4 is a flow diagram of a second method of forming a metasurface device, according to embodiments of the disclosure.

FIGS. 5A-5F are schematic cross sectional views of the metasurface device during the second method of FIG. 4, according to embodiments of the disclosure.

FIGS. 6A-6C are graphs illustrating optical transmission of metasurface devices with and without impedance matching layers at various pitches, according to embodiments of the disclosure.

FIGS. 7A-7C are graphs illustrating phase delay of metasurface devices with and without impedance matching layers at various pitches, according to embodiments of the disclosure.

FIGS. 8A and 8B are schematic cross sectional views of the metasurface device formed using a third method, according to embodiments of the disclosure.

### DETAILED DESCRIPTION

Embodiments of the present disclosure generally relate to optical devices. More specifically, embodiments described herein relate to metasurface devices and methods of forming metasurfaces with improved optical transmission performance.

Many flat optical devices, such as metasurfaces, are able to be manufactured with a high yield and low cost method. The flat optical devices include arrangements of structures with sub-micron dimensions, e.g., nanosized dimensions. Optical devices including flat optical devices may consist of a single layer or multiple layers of sub-micron structures leading to relatively small form factors when utilized in sensor or imaging apparatuses.

The optical transmission performance of metasurfaces is improved when one or more impedance matching layers are utilized along with a device layer within a plurality of device structures. The device structures are gratings, fins, or other nanostructures positioned on the substrate. In embodiments described herein, each of the device structures is formed from multiple layers, at least one of which is an impedance matching layer. The refractive indices of the impedance matching layers are chosen to be between the refractive index of the mediums on either side of the impedance matching layer. For instance, the refractive index of an impedance matching layer disposed between air and a device layer is between the refractive indices of both air and the device layer. For an impedance matching layer disposed between a substrate and a device layer, the refractive index of the impedance matching layer is between the refractive indices of both the substrate and the device layer.

Conventional metasurface devices have an optical transmission of about 85% to about 97% of the radiation which enters the metasurface device. By utilizing an additional impedance matching layer and matching the refractive index of the impedance matching layer, the optical transmission through a metasurface device is improved to greater than 97%, such as 99% or greater. The metasurface devices include a device layer which is chosen to obtain desired optical properties. The desired optical properties are tuned to determine the phase delay and the focus of the radiation passing through the metasurface device. As described herein, at least one impedance matching layer is disposed within each of the device structures.

The refractive index of each impedance matching layer is determined using a formula. The formula is shown herein as Equation 1.

n_{matching}≈\sqrt{n_{first medium}×n_{second medium}} Equation 1:

In Equation 1, n_{matching} is the refractive index of an impedance matching layer disposed between a first medium on one side and a second medium on the opposite side of the impedance matching layer. n_{first medium} is the refractive index of the first medium, while n_{second medium} is the refractive index of the second medium. The first and second mediums may be either a solid or a fluid, such as one or more optical material layers, air, or water. The actual refractive index of the impedance matching layer falls into a range around n_{matching}, such as about 25% greater than n_{matching} (i.e., 125% of n_{matching}) to about 25% less than n_{matching} (i.e., 75% of n_{matching}). The actual refractive index of the impedance matching layer may fall in a range of about 20% greater than n_{matching} (i.e., 120% of n_{matching}) to about 20% less than n_{matching} (i.e., being 80% of n_{matching}), such as about 10% greater than n_{matching} (i.e., being 110% of n_{matching}) to about 10% less than n_{matching} (i.e., being 90% of n_{matching}). Utilizing respective refractive indices outside of the ranges described herein result in lower efficiency of light transmission through the metasurface devices.

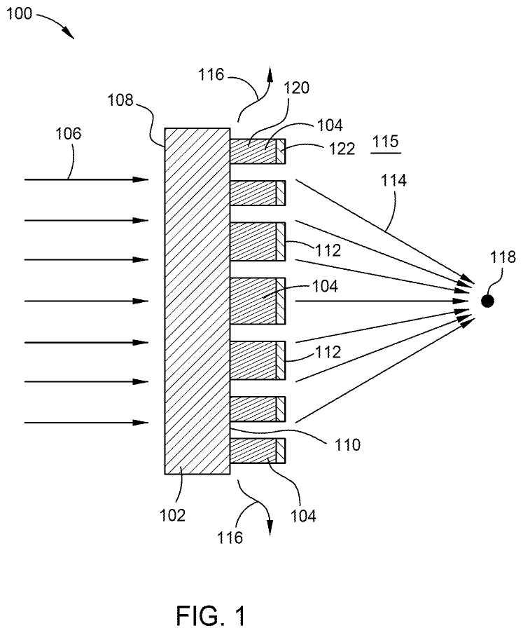

FIG. 1 is a schematic cross sectional view of a metasurface device 100. The metasurface device 100 includes a substrate 102 and a plurality of device structures 104 disposed on at least one side of the substrate 102. The substrate 102 includes a first surface 108 and a second surface 110. The plurality of device structures 104 may be a plurality of gratings, fins, or other nanostructures positioned on the substrate. In some embodiments, each of the nanostructures are cylinders, prisms, or pillars. The plurality of device structures 104 are coupled to the second surface 110 and extend outward from the second surface 110.

The plurality of device structures 104 change the phase delay and focal point of radiation passing through the metasurface device 100. As shown in FIG. 1, input radiation 106 enters the metasurface device 100 through the first surface 108 of the substrate 102. The input radiation 106 passes through the substrate 102, exits the substrate 102 into the plurality of device structures 104, and exits the device structures 104 from the tip 112 (e.g., distal end) of each of the device structures 104. After passing through the metasurface device 100, the input radiation 106 has been transformed into outgoing radiation 114. The outgoing radiation 114 is not collimated and is instead focused on a point 118. The outgoing radiation 114 exits the tip 112 of each device structure 104 and passes through a medium 115 disposed around the tip 112 and/or the sidewalls of the device structures 104. The medium 115 may be a fluid, such as air or water, or an optical layer, such as an encapsulating layer or another optical device. In some embodiments, the medium 115 includes a second metasurface device similar to the metasurface device 100.

The input radiation 106 may be at least partially absorbed, scattered, or reflected by the metasurface device 100. The unintentional reflection, scattering, or absorption of the input radiation 106 is shown as scattered radiation 116. The scattering/absorption of the input radiation 106 may lead to noise, decreases the efficiency of the metasurface device 100, and may cause the metasurface device 100 to be heated over time. It is beneficial to reduce the amount of scattered radiation 116 to increase the efficiency of the metasurface device 100. This is especially beneficial in embodiments where multiple metasurface devices 100 are stacked together. Utilizing an additional impedance matching layer 122 as part of the device structures 104 enables the efficiency of the metasurface device 100 to be increased and reduce the amount of scattered radiation 116, such that each of the device structures 104 include both a device layer 120 and an impedance matching layer, such as the impedance matching layer 122. As described herein, the impedance matching layer 122 assists in reducing or eliminating the scattered radiation 116.

Although the metasurface device 100 is shown focusing the input radiation 106, it is envisioned the device structures 104 may also be configured to produce other effects on the input radiation 106. In some embodiments, a metasurface device, such as the metasurface device 100 may be used in beam steering (e.g., beam diffusing, beam deflection, beam splitting, etc.) and the formation of holograms.

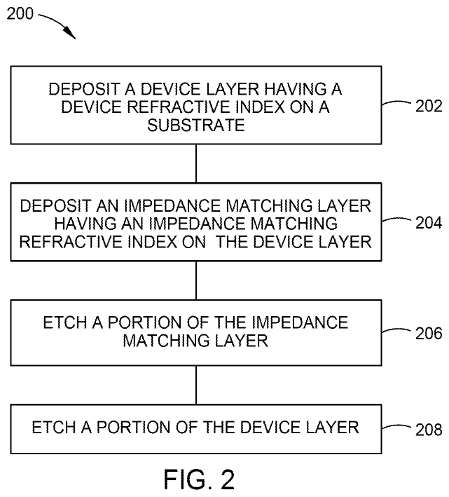

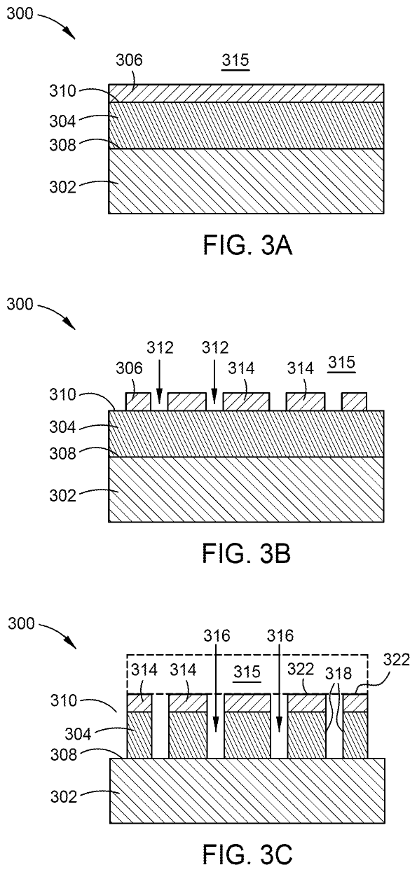

FIG. 2 is a flow diagram of a first method 200 of forming a metasurface device, such as the metasurface device 300 of FIGS. 3A-3C. The first method 200 includes an operation 202 of depositing a device layer 304 having a device refractive index onto a substrate 302. The device layer 304 is deposited on a top surface 308 of the substrate 302. The substrate has a substrate refractive index. The some embodiments, the substrate refractive index is different from the device refractive index.

The substrate 302 may be any suitable material. Suitable materials of the substrate 302 include, but are not limited to, amorphous dielectrics, non-amorphous dielectrics, crystalline dielectrics, silicon oxide, polymers, or combinations thereof. Suitable examples may include an oxide, sulfide, phosphide, telluride, or combinations thereof. For example, the substrate 302 includes silicon (Si), silicon dioxide (SiO2), germanium (Ge), silicon germanium (SiGe), InP, GaAs, GaN, fused silica, quartz, sapphire, high-index transparent materials such as high-refractive-index glass, combinations thereof, or other suitable materials. Additionally, the substrate 302 selection may further include varying shapes, thickness, and diameters of the substrate 302. For example, the substrate 302 may have a circular, rectangular, or square shape. Further, the substrate 302 may include multiple-layers.

The device layer 304 may be any suitable material for transforming properties of the radiation energy passing through the metasurface device 300. The thickness and material of the device layer 304 are chosen to obtain desired optical properties. Different optical properties may be desired for different applications. In some embodiments, the device layer 304 has a refractive index of about 1.9 to about 3.5, such as about 1.9 to about 2.0 or about 2.4 to about 2.6. The material of the device layer 304 is at least partially determined by the material of the substrate 302 as the device layer 304 is configured to produce a desired phase delay or transition through the metasurface device 300 and the resultant phase delay and transmission efficiency is dependent on both the refractive index of the substrate 302 and the device layer 304. The refractive index of the device may be described as a device refractive index or a first refractive index for brevity. The device layer 304 may be one or a combination of germanium (Ge), silicon (Si), silicon nitride (Si₃N₄), titanium oxide (TiO₂), hafnium oxide (HfO₂), tantalum oxide (Ta₂O₅), or scandium oxide (Sc₂O₃). Other materials are also contemplated.

After depositing the device layer 304, an outer impedance matching layer 306 is deposited on a top surface 310 of the device layer during an operation 204. The outer impedance matching layer 306 has an outer impedance refractive index. The outer impedance refractive index is determined at least partially by the refractive index of the device layer 304 as well as the refractive index of any layers/a medium 315 on the opposite side of the outer impedance matching layer 306 from the device layer 304. The medium 315 may be similar to the medium 115 of FIG. 1. In some embodiments, the medium 315 opposite the device layer 304 is air, water, or another fluid. In other embodiments, the medium 315 opposite the device layer 304 is an optical material, such as an optical cap or encapsulating layer. In some embodiments, the medium 315 is another optical device, such as another metasurface device 300. The refractive index of the outer impedance matching layer 306 is between the refractive index of the device layer 304 and the refractive index of the medium on the opposite side of the outer impedance matching layer 306, such as between the refractive index of the device layer 304 and the refractive index of air. The refractive index of the outer impedance matching layer may be described as an outer impedance refractive index or a second refractive index for brevity. In some embodiments, the outer impedance matching layer 306 is referred to as an anti-reflective layer.

The refractive index of the outer impedance matching layer may be about 1.4 to about 1.8, such as about 1.45 to about 1.8, such as about 1.45 to about 1.6. In some embodiments, the outer impedance matching layer 306 may be formed from a material containing one or more of germanium (Ge), silicon (Si), silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon carbon-nitride (SiCN), hafnium dioxide (HfO₂), combinations thereof, or other suitable materials. When utilizing any of germanium (Ge), silicon (Si), silicon nitride (Si₃N₄), titanium oxide (TiO₂), hafnium oxide (HfO₂), tantalum oxide (Ta₂O₅), or scandium oxide (Sc₂O₃) as the device layer 304, the outer impedance matching layer 306 may be one or a combination of silicon (Si), silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon carbon-nitride (SiCN), hafnium dioxide (HfO₂), combinations thereof, or other suitable materials. In some embodiments, when one or a combination of silicon (Si), silicon nitride (Si₃N₄), titanium oxide (TiO₂), hafnium oxide (HfO₂), tantalum oxide (Ta₂O₅), or scandium oxide (Sc₂O₃) are utilized as the device layer 304, the outer impedance matching layer 306 may be one or a combination of silicon nitride (Si₃N₄), silicon dioxide (SiO₂), or aluminum oxide (Al₂O₃). Other materials are also contemplated.

The refractive index of the device layer 304 and the outer impedance matching layer 306 are different, such that the difference between the refractive index of the device layer 304 and the refractive index of the outer impedance matching layer 306 is greater than 0.3, such as about 0.4 to about 2.5, such as about 0.4 to about 2.4, such as about 0.45 to about 1.9. In embodiments where the refractive index of the substrate 302 is below about 3.0, the difference between the refractive index of the device layer 304 and the refractive index of the outer impedance matching layer 306 is about 0.45 to about 1.2, such as about 0.45 to about 1.0, such as about 0.45 to about 0.9. In embodiments where the refractive index of the substrate 302 is above about 3.0, the difference between the refractive index of the device layer 304 is about 1.2 to about 2.5, such as about 1.2 to about 2.0, such as about 1.2 to about 1.9. The refractive index of the outer impedance matching layer 306 is configured to reduce the amount of scattered or absorbed light within the metasurface device 300 by creating a transition layer between the device layer 304 and the medium 315 opposite the outer impedance matching layer 306 from the device layer 304.

Equation 1 as discussed above is modified to obtain a relationship of a refractive index of each of the layers to the layers/mediums on each side of the layer. A first formula is used to determine the relationship of the outer impedance refractive index to both of the device refractive index and the refractive index of the medium 315 adjacent to the tip of each of the device structures 318. The first formula (i.e., “Formula 1”) determines a range within which the outer impedance refractive index falls relative to the refractive index of the medium 315 and the device refractive index. The first formula is: \sqrt{n_{medium}×n_{device}}×(0.75)≤n_{outer.impedance}≤\sqrt{n_{medium}×n_{device}}×(1.25), wherein n_{device} is the device refractive index, n_{medium} is a refractive index of the medium 315, and n_{outer.impedance} is the outer impedance refractive index. Therefore, the outer impedance refractive index as determined by the first formula is about \sqrt{n_{substrate}×n_{device}}×0.75 to about \sqrt{n_{substrate}×n_{device}}×1.25. The first formula enables the refractive index of the device to deviate in a window of about ±25%. In embodiments described herein, the medium 315 may be any one of another optical layer, an optical device, or a fluid medium which the device structures 318 are immersed. Potential optical layers include a capping layer. Potential optical devices include a lens or a second metasurface device. The fluid medium may be any one of an inert gas, air, water, or a hydrocarbon.

A second formula is used to determine the relationship of the impedance matching refractive index to both of the device refractive index and the refractive index of the medium 315 opposite the device layer 304 and contacting the outer impedance matching layer 306. The second formula as shown herein assumes the medium 315 surrounding the outer impedance matching layer 306 is air. The second formula determines a range within which the outer impedance refractive index falls. The second formula (i.e., “Formula 2”) is: \sqrt{nₐᵢᵣ×n_{device}}×0.75≤n_{outer.impedance}≤nₐᵢᵣ×n_{device}×1.25, wherein n_{device} is the device refractive index, nₐᵢᵣ is a refractive index of air, and n_{outer.impedance} is the outer impedance refractive index. Therefore, the outer impedance refractive index as determined by the second formula is about \sqrt{nₐᵢᵣ×n_{device}}×0.75 to about \sqrt{nₐᵢᵣ×n_{device}}×1.25. The second formula enables the refractive index of the outer impedance matching layer 306 to deviate in a window of about ±25%. If the surrounding medium is not air, then nₐᵢᵣ may be replaced with a refractive index of another fluid or material forming the medium 315.

In another example, a device layer 304 having a device refractive index of about 2.3 to about 2.7, such as about 2.4 to about 2.6, is combined with an outer impedance matching layer 306 having an outer impedance refractive index of about 1.35 to about 1.7, such as about 1.45 to about 1.6. In this embodiment, the device layer 304 is titanium oxide and the outer impedance matching layer 306 is silicon dioxide or aluminum oxide, and each of the device structures 318 extend through air.

In yet another example, a device layer 304 having a device refractive index of about 1.8 to about 2.1, such as about 1.9 to about 2.0, is combined with an outer impedance matching layer 306 with an outer impedance refractive index of about 1.35 to about 1.55, such as about 1.45. In this embodiment, the device layer 304 is one or a combination of silicon nitride, hafnium oxide, tantalum oxide, or scandium oxide and the outer impedance matching layer 306 is silicon dioxide.

The device layer 304 and the outer impedance matching layer 306 are formed using a suitable deposition operation, such as a chemical vapor deposition (CVD), physical vapor deposition (PVD), or atomic layer deposition (ALD) operation. In some embodiments, the device layer 304 and/or the outer impedance matching layer 306 are spin coated onto the substrate 302.

After depositing both the device layer 304 and the outer impedance matching layer 306, the metasurface device 300 is similar to the metasurface device 300 of FIG. 3A. Once both the device layer 304 and the outer impedance matching layer 306 are formed, a portion of the outer impedance matching layer 306 is etched during an operation 206. Etching the outer impedance matching layer 306 may include one or more sub-operations, such as exposure/patterning of the outer impedance matching layer 306. The outer impedance matching layer 306 may be selectively etched to leave a desired pattern of impedance structures 314 disposed on the device layer 304 as shown in FIG. 3B. The etch operation may be a dry etch or a wet etch. In some embodiments, the etch operations described herein are plasma etch operations. The desired pattern may be a plurality of discreet posts or gratings. Different patterns may be utilized to obtain a variety of optical effects. In some embodiments, the impedance structures 314 are a plurality of pillars or a plurality of prisms extending from the top surface 310 of device layer 304. The impedance structures 314 are separated by openings 312. The openings 312 are gaps between each of the impedance structures 314. Each of the impedance structures 314 may be a different size/shape to obtain a desired optical pattern.

After etching the outer impedance matching layer 306, a portion of the device layer 304 is etched during another operation 208. The device layer 304 is etched through the outer impedance matching layer 306, such that the outer impedance matching layer 306 may act as a mask during etching of the device layer 304. The pattern of the outer impedance matching layer 306 may be transferred to the device layer 304 to form a plurality of device structures 318 as shown in FIG. 3C. The device structures 318 are formed using selective etching through the openings 312 of the impedance structures 314. The etch operation may be a dry etch or a wet etch. In some embodiments, the etch operations described herein are plasma etch operations.

The device structures 318 are separated by openings 316. The openings 316 are gaps between each of the device structures 318. Each of the device structures 318 may be a different size/shape to obtain a desired optical pattern. The device structures 318 having the outer impedance matching layer 306 disposed thereon provides a transition layer with a refractive index between the device refractive index and the refractive index of the medium 315 on the opposite side of the outer impedance matching layer 306 from the device structures 318. In some embodiments, the device structures 318 include both the remaining portions of the device layer 304 and the impedance structures 314. Each of the device structures 318 includes a tip 322. The tip 322 of each of the device structures 318 is the distal end of each device structure 318 furthest from the top surface 308 of the substrate 302. In some embodiments, the operations 206 and 208 may be the same operation, such that the outer impedance matching layer 306 and the device layer 304 are etched during the same operation.

In embodiments wherein the medium 315 includes an optical material or another optical device, the material of the medium 315 adjacent to and/or contacting the tip 322 of each of the device structures 318 has a refractive index different from the refractive index of the impedance structures 314. In some embodiments, the medium 315 has a refractive index of less than the refractive index of the impedance structures 314, such as a refractive index of less than about 2.0, such as a refractive index of less than about 1.8.

The pitch between each of the device structures 318 is a distance between a center of one device structure and a center of an immediately adjacent device structure. The pitch may vary over the surface of the metasurface device 300 to enable desired optical patterning. In embodiments described herein, the pitch is about 250 nm to about 750 nm, such as about 250 nm to about 500 nm, such as about 300 nm to about 500 nm, such as about 350 nm to about 450 nm, such as about 300 nm, about 400 nm, or about 500 nm. Other pitch sizes are also envisioned and may be utilized for certain optical configurations or uses.

Although shown as a separate layer, in some embodiments, the device layer 304 is part of the substrate 302 and the substrate 302 is patterned to form the device structures 318. In other embodiments, the device layer 304 may be formed before or after processing.

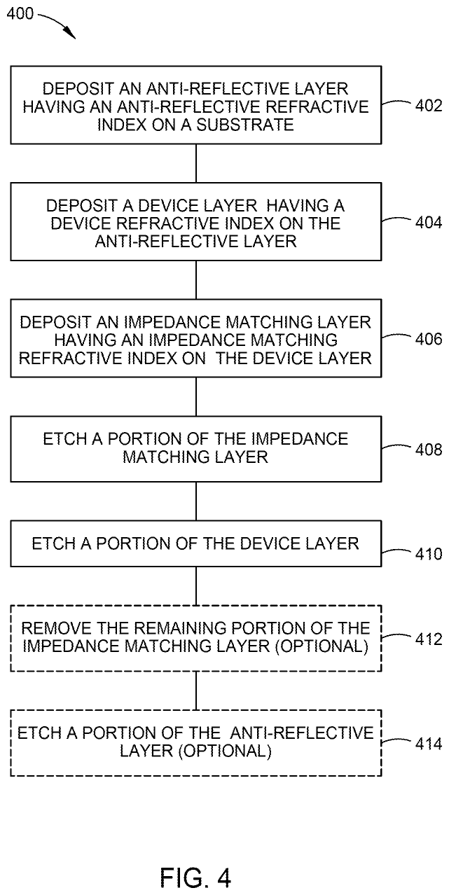

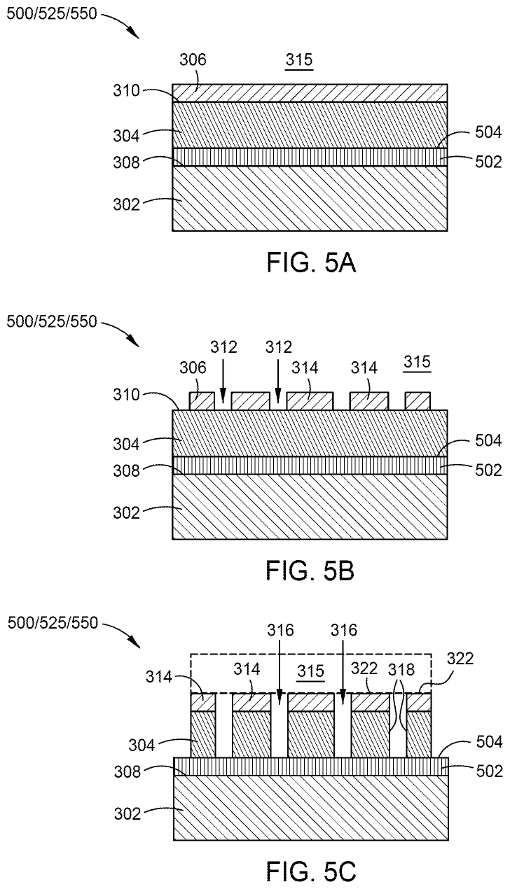

FIG. 4 is a flow diagram of a second method 400 of forming a metasurface device, such as one of the metasurface devices 500, 525, 550 of FIGS. 5A-5F. The second method 400 is similar to the first method 200, but includes forming an inner impedance matching layer 502 on the top surface 308 of the substrate 302 during an operation 402. The inner impedance matching layer 502 is deposited on the substrate 302. The inner impedance matching layer 502 reduces the amount of radiation reflected through the metasurface devices 500, 525, 550. In some embodiments, the inner impedance matching layer 502 is referred to as an anti-reflective layer. The inner impedance matching layer 502 has a refractive index of about 1.4 to about 2.5, such as about 1.6 to about 2.2. The refractive index of the inner impedance matching layer 502 may be described as an inner impedance refractive index or a third refractive index for brevity. The inner impedance matching layer 502 is formed from a suitable material, such as one or a combination of Al₂O₃, HfO₂, TiSiₓO_{y}, SiOₓN_{y}, or other suitable materials. In some embodiments, the inner impedance matching layer 502 (if not etched through) is utilized as an etch-stop layer. The inner impedance matching layer 502 may therefore serve a dual purpose of providing impedance matching and preventing etching of the substrate 302.

After depositing the inner impedance matching layer 502, the device layer 304 is formed on the top surface 504 of the inner impedance matching layer 502 during an operation 404. The operation 404 is similar to the operation 202 of the first method 200. The device layer 304 is similar to the device layer 304 of FIGS. 3A-3C as described in the first method 200. After deposition the device layer 304 during the operation 404, an outer impedance matching layer 306 is deposited on top of the device layer 304 during an operation 406. The operation 406 is similar to the operation 204 of the first method 200. The outer impedance matching layer 306 is similar to the outer impedance matching layer 306 of FIGS. 3A-3C as described in the first method 200.

Equation 1 as discussed above is utilized to obtain a relationship of a refractive index of each of the intermediate layers to the layers on each side of the intermediate layer. A third formula is used to determine the relationship of the refractive index of the inner impedance matching layer 502 to both of the substrate refractive index and the device refractive index. The third formula (i.e., “Formula 3”) determines a range within which the refractive index of the inner impedance matching layer 502 falls. The third formula is: \sqrt{n_{substrate}×n_{device}}×0.75≤n_{inner.impedance}≤\sqrt{n_{substrate}×n_{device}}×1.25, wherein n_{device} is the device refractive index, n_{substrate} is a substrate refractive index of the substrate, and n_{inner.impedance} is the refractive index of the inner impedance matching layer 502. Therefore, the refractive index of the inner impedance matching layer 502 as determined by the third formula is about \sqrt{n_{substrate}×n_{device}}×0.75 to about \sqrt{n_{substrate}×n_{device}}×1.25. The third formula enables the refractive index of the inner impedance matching layer 502 to deviate in a window of about ±25%.

After depositing each of the inner impedance matching layer 502, the device layer 304, and the outer impedance matching layer 306, a portion of the outer impedance matching layer 306 is etched during an operation 408. The operation 408 is similar to the operation 206 of the first method 200. After the operation 408, the metasurface device 500, 525, 550 is similar to that shown in FIG. 5B. After etching the outer impedance matching layer 306 during the operation 408, a portion of the device layer 304 is etched during an operation 410. The operation 410 is similar to the operation 208 of the first method 200. After the operation 410, the metasurface device 500, 525, 550 is similar to that shown in FIG. 5C.

After etching the device layer 304 to form the device structures 318, one or both of removing the remaining portions of the outer impedance matching layer 306 during an operation 412 or etching a portion of the inner impedance matching layer 502 during an operation 414 are optionally performed. The optional removal of the outer impedance matching layer 306 is illustrated in FIG. 5D, such that each of the impedance structures remaining on the device structures 318 are removed. The impedance structured may be removed using an etch operation or may be dissolved in a solution. The etch operation may be a dry etch or a wet etch. In some embodiments, the etch operations described herein are plasma etch operations. In embodiments wherein the outer impedance matching layer 306 is removed, the inner impedance matching layer 502 may act as an impedance matching layer between the substrate 302 and the device structures 318.

After removing the outer impedance matching layer 306, a portion of the inner impedance matching layer 502 is removed during the operation 414. The removal of a portion of the inner impedance matching layer 502 forms a plurality of anti-reflective structures 508 with openings 506 disposed therebetween. One or both of the device structures 318 and the impedance structures 314 may act as a mask to enable etching of the inner impedance matching layer 502. FIG. 5E illustrates an embodiment wherein both of operation 412 and operation 414 are performed. The inner impedance matching layer 502 may be removed using an etching process. The etching may utilize a wet or a dry etch chemistry.

In some embodiments, the outer impedance matching layer 306 is not removed, but a portion of the inner impedance matching layer 502 is etched during the operation 414. The embodiment wherein the outer impedance matching layer 306 is not removed and a portion of the inner impedance matching layer 502 is etched is illustrated in FIG. 5F.

To form the embodiment of FIG. 5E, operation 412 and operation 414 may be performed in either order, such that operation 412 is performed before operation 414 or operation 414 is performed before operation 412.

A first metasurface device 500 includes the plurality of device structures 318 formed on top of an inner impedance matching layer 502 as illustrated in FIG. 5D. The first metasurface device 500 does not include the outer impedance matching layer 306. The inner impedance matching layer 502 in the first metasurface device 500 is a continuous layer as illustrated in FIG. 5D.

A second metasurface device 525 includes the plurality of device structures 318 formed on top of the inner impedance matching layer 502 as illustrated in FIG. 5E. The second metasurface device 525 is similar to the first metasurface device 500, but the inner impedance matching layer 502 is discontinuous and openings 506 are formed between the anti-reflective structures 508. In the second metasurface device 525, portions of the top surface 308 of the substrate 302 are exposed.

A third metasurface device 550 includes the plurality of device structures 318 formed on top of the inner impedance matching layer 502 as illustrated in FIG. 5F. The device structures 318 include the impedance structures 314 disposed thereon to perform impedance matching of the device structures 318. The inner impedance matching layer 502 is discontinuous, such that each of the device structures 318 includes an anti-reflective structure 508, a portion of the device layer 304, and the impedance structures 314.

Although shown as a separate layer, in some embodiments, the inner impedance matching layer 502 and/or the device layer 304 are part of the substrate 302 and the substrate 302 is patterned to form the anti-reflective structures 508 and/or the device structures 318. In other embodiments, the device layer 304 may be formed before or after processing.

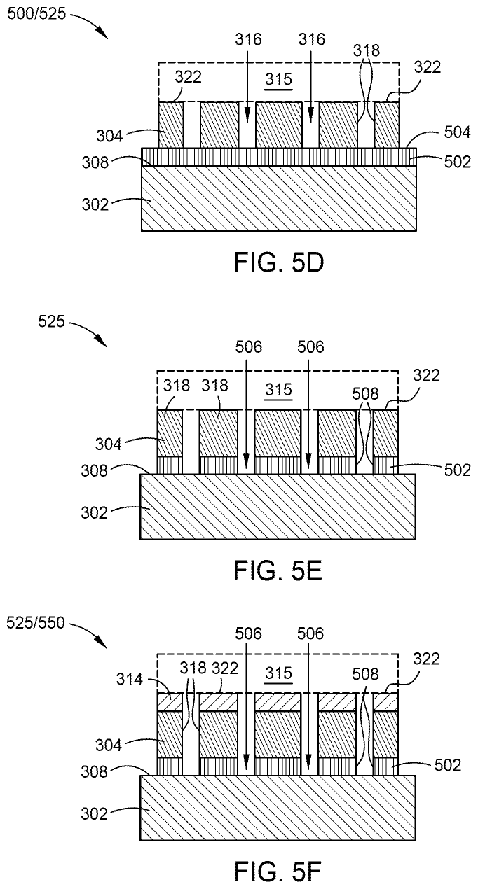

FIGS. 6A-6C are graphs 602, 604, 606 illustrating optical transmission of metasurface devices with and without impedance matching layers. The first graph 602 of FIG. 6A illustrates optical transmission through a metasurface device where the pitch is about 350 nm. The second graph 604 of FIG. 6B illustrates optical transmission through a metasurface device where the pitch is about 400 nm. The third graph 606 of FIG. 6C illustrates optical transmission through a metasurface device where the pitch is about 450 nm.

The dependent variable of each of the graphs 602, 604, 606 is the duty cycle of the radiation, while the independent variable of each of the graphs 602, 604, 606 is the transmission through the metasurface devices.

Each of the data sets 608, 612, 616 of the graphs 602, 604, 606 assumes an operating radiation wavelength of about 940 nm, a refractive index of a silicon device layer being about 3.88, a refractive index of a silicon nitride impedance matching layer being about 1.95, and a refractive index of a substrate of about 1.45.

Each of the data sets 610, 614, 618 of the graphs 602, 604, 606 assumes an operating radiation wavelength of about 940 nm, a refractive index of a silicon device layer being about 3.88, and a refractive index of a substrate of about 1.45. The data sets 610, 614, 618 of the graphs 602, 604, 606 do not have an impedance matching layer as described herein.

As illustrated, the average transmission through the metasurface devices is improved to about 99% or greater when utilizing an impedance matching layer. The average transmission without the metasurface devices is at or below 97%.

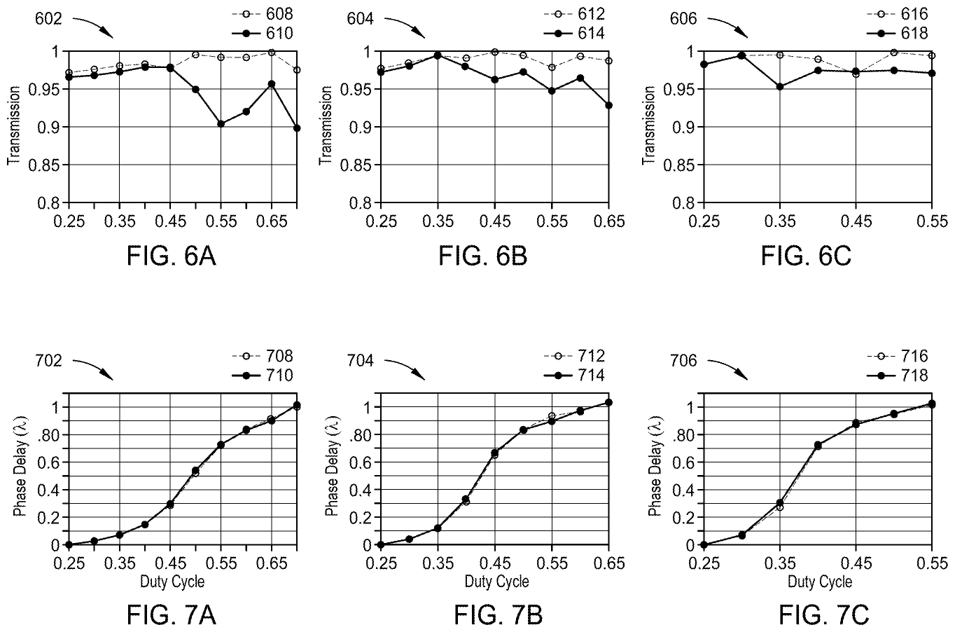

FIGS. 7A-7C are graphs 702, 704, 706 illustrating phase delay of metasurface devices with and without impedance matching layers. Graph 702 of FIG. 7A correlates to graph 602 of FIG. 6A. Graph 704 of FIG. 7B correlates to graph 604 of FIG. 6B. Graph 706 of FIG. 7C correlates to graph 606 of FIG. 6C. The dependent variable of each of the graphs 702, 704, 706 is the duty cycle of the radiation, while the independent variable of each of the graphs 702, 704, 706 is the phase delay through the metasurface devices.

Each of the data sets 708, 712, 716 of the graphs 702, 704, 706 uses an operating radiation wavelength of about 940 nm, a refractive index of a silicon device layer being about 3.88, a refractive index of a silicon nitride impedance matching layer being about 1.95, and a refractive index of a substrate of about 1.45.

Each of the data sets 710, 714, 718 of the graphs 702, 704, 706 uses an operating radiation wavelength of about 940 nm, a refractive index of a silicon device layer being about 3.88, and a refractive index of a substrate of about 1.45. The data sets 710, 714, 718 of the graphs 702, 704, 706 do not have an impedance matching layer as described herein.

As illustrated, similar phase delay may be obtained whether the metasurface devices utilize an impedance matching layer or if they do not utilize an impedance matching layer.

Therefore, impedance matching layers as described herein enable increased transmission efficiency of radiation through metasurface devices without detriment to phase delay control. The impedance matching layers are therefore beneficial in enabling increased efficiency of the metasurface devices. The impedance matching layers have a refractive index between the refractive index of the mediums on either side of the impedance matching layers. In some embodiments, one of the mediums is air, while the other medium is a device layer. In some embodiments, multiple impedance matching layers are utilized, such as an inner impedance matching layer and an impedance matching layer or two or more impedance matching layers.

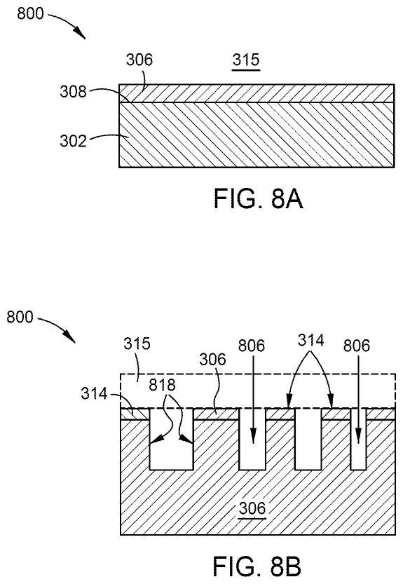

FIGS. 8A and 8B are schematic cross sectional views of another embodiment of a metasurface device 800 formed using a third method. The metasurface device 800 is formed such that a device layer is a part of the substrate 302, such that a separate device layer is not formed and instead, the substrate 302 is etched partially through to form a plurality of device structures 818. As shown in FIG. 8A, an outer impedance matching layer 306 is formed on the top surface 308 of the substrate 302. The substrate 302 may be a similar material to that described previously, or the substrate may be a material similar to the device layer 304 of FIGS. 3A-3C and 5A-5F.

In some embodiments, which may be combined with other embodiments, an inner impedance matching layer similar to the inner impedance matching layer 502 is formed on the top surface 308 of the substrate 302 prior to forming the outer impedance matching layer 306. The inner impedance matching layer may be patterned to form arc structures disposed on the device structures 818. In other embodiments, the inner impedance matching layer may be disposed within the substrate 302. The device layer may be formed before or after processing.

One or more etching processes similar to those described above are then utilized to form the plurality of device structures 818. During the etch processes, the outer impedance matching layer 306 is patterned to form impedance structures 314 using a first etching process and the substrate 302 is etched through the patterned outer impedance matching layer 306 to form a plurality of openings 806 or divots in the substrate 302 from the top surface 308 during a second etching process. The plurality of device structures 818 are therefore formed at least in part by the non-etched portions of the substrate 302 and the remaining portions of the outer impedance matching layer 306. The outer impedance matching layer 306 is similar to the outer impedance matching layers 306 of FIGS. 3A-3C and 5A-5F.

The refractive index of the outer impedance matching layer 306 as described with respect to FIGS. 8A and 8B is determined using a fourth formula. The fourth formula is used to determine the relationship of the outer impedance refractive index to both of the substrate refractive index and the refractive index of the medium 315 adjacent to the tip of each of the device structures 818. The fourth formula (i.e., “Formula 4”) determines a range within which the outer impedance refractive index falls. The first formula is: \sqrt{n_{medium}×n_{substrate}}×(0.75)≤n_{outer.impedance}≤\sqrt{n_{medium}×n_{substrate}}×(1.25), wherein n_{substrate} is the device refractive index, n_{medium} is a refractive index of the medium 315, and n_{outer.impedance} is the outer impedance refractive index. Therefore, the outer impedance refractive index as determined by the fourth formula is about \sqrt{n_{substrate}×n_{substrate}}×0.75 to about \sqrt{n_{substrate}×n_{substrate}}×1.25. The fourth formula enables the refractive index of the device to deviate in a window of about ±25%.

While the foregoing is directed to embodiments of the present disclosure, other and further embodiments of the disclosure may be devised without departing from the basic scope thereof, and the scope thereof is determined by the claims that follow.

1. A metasurface device, comprising:
a substrate;
a plurality of device structures disposed over the substrate, adjacent device structures of the plurality of device structures defining a gap therebetween, each device structure comprising:
a device layer, the device layer including a device material having a device refractive index of about 1.9 to about 3.5; and
an impedance matching layer having an impedance refractive index and contacting the device layer, wherein, the impedance refractive index is about 1.4 to 1.8.

2. The metasurface device of claim 1, wherein the impedance refractive index is between a refractive index of a medium disposed around a tip of each of the device structures and the device refractive index.

3. The metasurface device of claim 2, wherein the medium is air and the impedance refractive index is a refractive index of air.

4. The metasurface device of claim 1, wherein the impedance refractive index falls in a range produced by a second formula, wherein the second formula is: \sqrt{nₐᵢᵣ×n_{device}}×0.75≤n_{outer.impedance}≤\sqrt{nₐᵢᵣ×n_{device}}×1.25, wherein nₐᵢᵣ is a refractive index of air, n_{device} is the device refractive index, and n_{outer.impedance} is the refractive index of impedance matching layer.

5. The metasurface device of claim 1, wherein each device structure further comprises an inner impedance matching layer disposed between the substrate and the device layer, the inner impedance matching layer having an inner impedance refractive index of about 1.4 to about 2.5.

6. The metasurface device of claim 5, wherein the inner impedance refractive index falls in a range produced by a third formula, wherein the third formula is: \sqrt{n_{substrate}×n_{device}}×0.75≤n_{inner.impedance}≤\sqrt{n_{substrate}×n_{device}}×1.25, wherein n_{substrate} is the substrate refractive index, n_{device} is the device refractive index, and n_{inner.impedance} is the inner impedance refractive index.

7. The metasurface device of claim 1, wherein the device refractive index is about 2.3 to about 2.7 and the impedance refractive index is about 1.35 to about 1.7.

8. The metasurface device of claim 1, wherein the device layer comprises titanium oxide and the impedance matching layer comprises silicon dioxide or aluminum oxide.

9. The metasurface device of claim 1, wherein the device refractive index is about 1.8 to about 2.1 and the impedance refractive index is about 1.35 to about 1.55.

10. A metasurface device, comprising:
a substrate;
a plurality of device structures disposed over the substrate, adjacent device structures of the plurality of device structures defining a gap therebetween, each device structure comprising:
an inner impedance matching layer disposed on a top surface of the substrate and having an inner impedance refractive index;
a device layer disposed on the inner impedance matching layer and having a device refractive index; and
an outer impedance matching layer disposed on the device layer and having an outer impedance refractive index,
wherein the inner impedance refractive index is between a substrate refractive index and the device refractive index.

11. The metasurface device of claim 10, wherein the inner impedance refractive index is about 1.4 to about 2.5.

12. The metasurface device of claim 10, wherein the inner impedance refractive index falls in a range produced by a third formula, wherein the third formula is: \sqrt{n_{substrate}×n_{device}}×0.75≤n_{inner.impedance}≤\sqrt{n_{substrate}×n_{device}}×1.25, wherein n_{substrate} is the substrate refractive index, n_{device} is the device refractive index, and n_{inner.impedance} is the inner impedance refractive index.

13. The metasurface device of claim 10, wherein:
the device layer is one or a combination of germanium (Ge), silicon (Si), silicon nitride (Si₃N₄), titanium oxide (TiO₂), hafnium oxide (HfO₂), tantalum oxide (Ta₂O₅), or scandium oxide (Sc₂O₃); and
the outer impedance matching layer is one or a combination of germanium (Ge), silicon (Si), silicon carbide (SiC), silicon oxycarbide (SiOC), titanium dioxide (TiO₂), silicon dioxide (SiO₂), vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), zirconium dioxide (ZrO₂), niobium oxide (Nb₂O₅), cadmium stannate (Cd₂SnO₄), silicon carbon-nitride (SiCN), or hafnium dioxide (HfO₂).

14. A method of forming an optical device, comprising:
forming a material layer stack comprising:
a device layer disposed on a substrate, the device layer having a device refractive index of about 1.9 to about 3.5 and the substrate having a substrate refractive index; and
an outer impedance matching layer disposed on the device layer, the outer impedance matching layer having an outer impedance refractive index of about 1.4 to about 1.8, wherein the outer impedance refractive index is between the device refractive index and a surrounding-medium refractive index;
etching a portion of the outer impedance matching layer to form a hardmask, and
etching the device layer through the hardmask to form a plurality of device structures.

15. The method of claim 14, wherein an inner impedance matching layer is disposed between the device layer and the substrate and has an inner impedance refractive index between the substrate refractive index and the device refractive index.

16. The method of claim 15, further comprising etching the inner impedance matching layer through openings formed in the device layer after etching the device layer.

17. The method of claim 16, further comprising removing the hardmask after forming the plurality of device structures.

18. The method of claim 15, wherein the inner impedance refractive index is about 1.4 to about 2.5.

19. The method of claim 18, wherein the inner impedance refractive index falls in a range produced by a third formula, wherein the third formula is: \sqrt{n_{substrate}×n_{device}}×0.75≤n_{inner.impedance}≤\sqrt{n_{substrate}×n_{device}}×1.25, wherein n_{substrate} is the substrate refractive index, n_{device} is the device refractive index, and n_{inner.impedance} is the inner impedance refractive index.

20. The method of claim 15, wherein the device layer is one or a combination of germanium (Ge), silicon (Si), silicon nitride (Si₃N₄), titanium oxide (TiO₂), hafnium oxide (HfO₂), tantalum oxide (Ta₂O₅), or scandium oxide (Sc₂O₃).
